(19) United States
(12) Patent Application Publication
(10) Pub. No.: US 2015/0009089 A1
(43) Pub. Date: Jan. 8, 2015

(54) ANTENNAS

(71) Applicant: L-com, Inc., North Andover, MA (US)

(72) Inventors: Patrick Pesa, Boca Raton, FL (US); Tang Hong, Foshan City (CN); Liao Zhenlin, Foshan City (CN)

(21) Appl. No.: 14/325,884

(22) Filed: Jul. 8, 2014

Related U.S. Application Data
(60) Provisional application No. 61/843,653, filed on Jul. 8, 2013.

(51) Int. Cl. H01Q 21/00

(52) U.S. Cl. CPC H01Q 21/0075
USPC 343/872; 343/893

(57) ABSTRACT

One aspect of the invention provides an antenna including: a dielectric substrate and a plurality of antenna elements positioned on a surface of the dielectric substrate. Each antenna element includes: a sector-shaped sheet of conductive material and a conductive feed line coupled to the sector-shape sheet of conductive material. Another aspect of the invention provides an antenna including: a dielectric substrate, a plurality of antenna elements positioned on a surface of the dielectric substrate at substantially uniform angular intervals along an arc, and a ground layer mounted to an opposite side of the dielectric substrate from the plurality of antenna elements. Each antenna element includes: a sector-shaped sheet of conductive material having a central angle between about 90° and about 180° and a conductive feed line coupled to the sector-shape sheet of conductive material.

### CROSS-REFERENCE TO RELATED APPLICATION

This application claims priority to U.S. Provisional Patent Application Ser. No. 61/843,653, filed July 8, 2013. The entire content of this application is hereby incorporated by reference herein.

### BACKGROUND OF THE INVENTION

Along with development of wireless communication, wide-band and wide-area coverage becomes a need of users. Most commercially-available antennas do not provide 180 degree horizontal beamwidth and do not support both 2.4-2.5 GHz and 4.9-5.9 GHz frequencies. Existing wide-band and wide-area antennas are expensive, which prevents wide adoption.

### SUMMARY OF THE INVENTION

One aspect of the invention provides an antenna including: a dielectric substrate and a plurality of antenna elements positioned on a surface of the dielectric substrate. Each antenna element includes: a sector-shaped sheet of conductive material and a conductive feed line coupled to the sector-shape sheet of conductive material.

This aspect of the invention can have a variety of embodiments. The plurality of antenna elements can be arranged in an arc. The plurality of antenna elements can be positioned at substantially uniform angular intervals along the arc. The plurality of antenna elements can consist of six antenna elements. The sector-shaped sheet of conductive material can have a central angle between about 0° and about 180°. The sector-shaped sheet of conductive material can have a central angle between about 90° and about 180°. The sector-shaped sheet of conductive material can have a central angle selected from the group consist of: between about 90° and about 100°, between about 100° and about 110°, between about 110° and about 120°, between about 120° and about 130°, between about 130° and about 140°, between about 140° and about 150°, between about 150° and about 160°, between about 160° and about 170°, and between about 170° and about 180°.

The conductive feed line can include a longitudinal portion and a lateral portion adjacent to the sector-shaped sheet of conductive material and at a substantially right angle to the longitudinal portion.

The antenna can further include a ground layer mounted to an opposite side of the dielectric substrate from the plurality of antenna elements.

The antenna can further include a plurality of RF connectors. Each RF connector can be associated with one of the plurality of antenna elements.

The antenna can further include a housing surrounding the substrate and the plurality of antenna elements.

Another aspect of the invention provides an antenna including: a dielectric substrate, a plurality of antenna elements positioned on a surface of the dielectric substrate at substantially uniform angular intervals along an arc, and a ground layer mounted to an opposite side of the dielectric substrate from the plurality of antenna elements. Each antenna element includes: a sector-shaped sheet of conductive material having a central angle between about 90° and about 180° and a conductive feed line coupled to the sector-shape sheet of conductive material. The conductive feed line includes a longitudinal portion and a lateral portion adjacent to the sector-shaped sheet of conductive material and at a substantially right angle to the longitudinal portion.

Another aspect of the invention provides a printed-circuit board antenna including: a dielectric substrate and at least six antenna elements etched on a surface of the dielectric substrate to form a 3×3 MIMO array. Each antenna element can include: a sector-shaped sheet of conductive material and a conductive feed line coupled to the sector-shape sheet of conductive material.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIGS. 1A-1D depict an antenna according to an embodiment of the invention;

FIGS. 2A and 2B depict an antenna element according to an embodiment of the invention;

FIGS. 2C and 2D depict a portion of a ground layer corresponding to an antenna element according to an embodiment of the invention;

FIGS. 3A-3D depict a housing according to an embodiment of the invention;

FIGS. 4A and 4B depict VSWR plots for an antenna element according to an embodiment of the invention;

FIG. 5 depicts 3D radiation pattern simulation results at 2.45 GHz according to an embodiment of the invention;

FIGS. 6A and 6B depict YOZ and XOY plane simulation results at 2.45 GHz according to an embodiment of the invention;

FIG. 7 depicts 3D radiation pattern simulation results at 5 GHz according to an embodiment of the invention;

FIGS. 8A and 8B depict YOZ and XOY plane simulation results at 5 GHz. according to an embodiment of the invention;

FIG. 9 depicts 3D radiation pattern simulation results at 5.5 GHz according to an embodiment of the invention;

FIG. 10A and 10B depict YOZ and XOY plane simulation results at 5.5 GHz according to an embodiment of the invention;

FIG. 11 depicts 3D radiation pattern simulation results at 6 GHz according to an embodiment of the invention;

FIGS. 12A and 12B provides YOZ and XOY plane simulation results at 6 GHz according to an embodiment of the invention; FIG. 13A and 13B depict an antenna element having an increased length according to an embodiment of the invention;

FIG. 13C depicts a VWSR plot for the antenna element depicted in FIG. 13A according to an embodiment of the invention;

FIG. 14A depicts an antenna element having an increased length according to an embodiment of the invention;

FIG. 14B depicts a VWSR plot for the antenna element depicted in FIG. 14A according to an embodiment of the invention;

FIGS. 15A-15D depict a schematic for an antenna having an array of antenna elements according to an embodiment of the invention;

FIG. 16 depicts a VSWR plot for an antenna according to an embodiment of the invention;

FIG. 17 depicts 3D radiation patterns simulation results for 2.45 GHz according to an embodiment of the invention;

FIGS. 18A and 18B depict YOZ and XOY plane simulation results, respectively, at 2.45 GHz according to an embodiment of the invention;

FIG. 19 depicts 3D radiation patterns simulation results for 4.9 GHz according to an embodiment of the invention;

FIGS. 20A and 20B depict YOZ and XOY plane simulation results, respectively, at 4.9 GHz according to an embodiment of the invention;

FIG. 21 depicts a 3D radiation patterns simulation result for 5.5 GHz according to an embodiment of the invention;

FIGS. 22A and 22B depict YOZ and XOY plane simulation results, respectively, at 5.5 GHz according to an embodiment of the invention;

FIG. 23 depicts a 3D radiation patterns simulation result for 5.9 GHz according to an embodiment of the invention; and

FIGS. 24A and 24B depict YOZ and XOY plane simulation results, respectively, at 5.9 GHz according to an embodiment of the invention.

### DEFINITIONS

The instant invention is most clearly understood with reference to the following definitions:

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

### Antennas

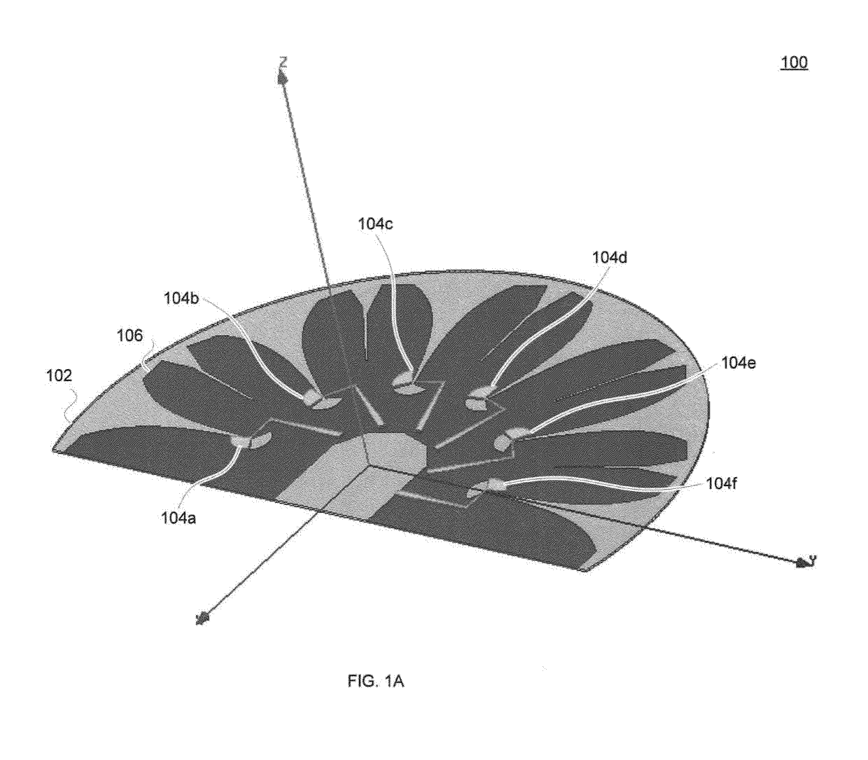

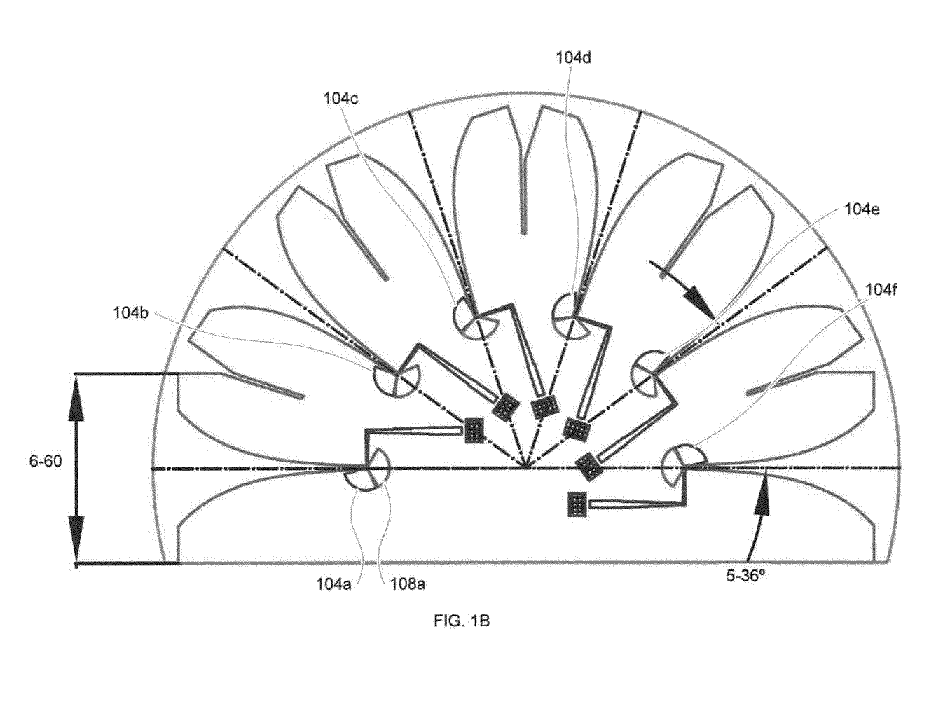

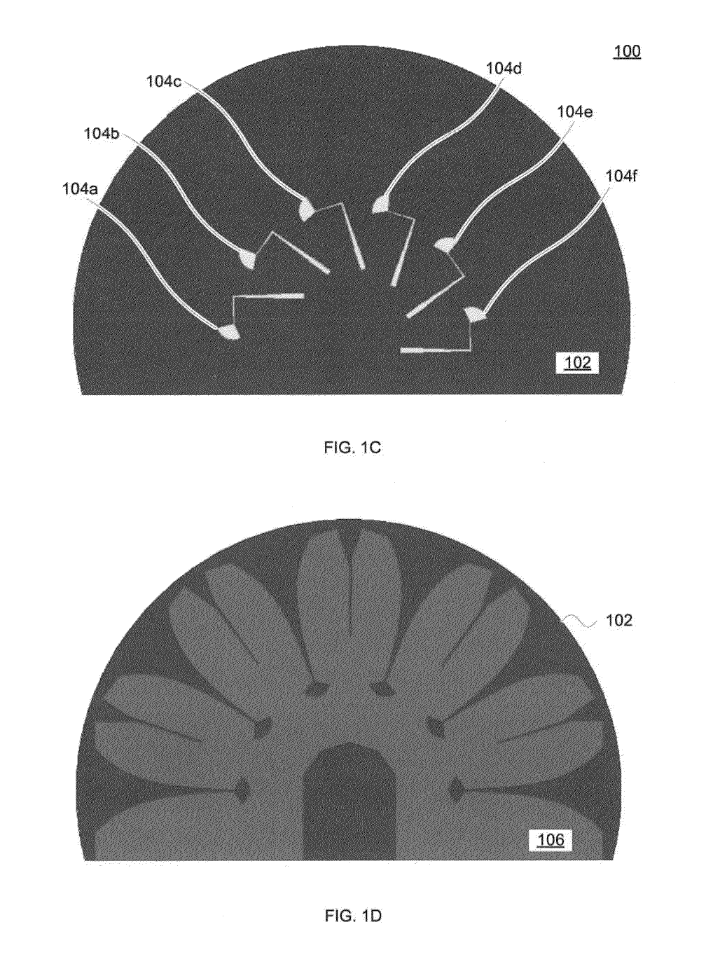

Referring now to FIGS. 1A-1C, an antenna 100 is provided. Antenna 100 includes a dielectric substrate 102, a plurality of antenna elements 104 (e.g., 2, 3, 4, 5, 6, 7, 8, 9, 10, 11, 12, and the like) positioned on a first surface of the dielectric substrate 102, and a ground layer 106 mounted to an opposite surface of the dielectric substrate 102.

Dielectric substrate 102 is depicted as substantially transparent in FIGS. 1A and 1B so that the relative positioning of antenna elements 104 with respect to the geometry of ground layer 106 is visible, but can be opaque or translucent as depicted in FIGS. 1B and 1C. Dielectric substrate 102 can be fabricated from a variety of materials used in the manufacturing of electronic devices such as printed circuit boards. For example, dielectric substrate 102 can be fabricated from silicon, silicon dioxide, aluminum oxide, sapphire, germanium, gallium arsenide (GaAs), an alloy of silicon and germanium, indium phosphide (InP), and the like. In some embodiments, the dielectric substrate 102 has a thickness of about 0.8 mm and a dielectric constant of about 2.55.

Antenna elements 104 and ground layer 106 can be conductive materials such as metals such as copper and can be applied to dielectric substrate using techniques such as subtractive, additive, and semi-additive processes. Specific examples include silk screen printing, photoengraving, PCB milling, and electroplating. Suitable manufacturing processes are described in detail in texts such as Charles Harper, Electronic Assembly Fabrication (2002) and R. Khandpur, Printed Circuit Boards: Design, Fabrication, and Assembly (2005).

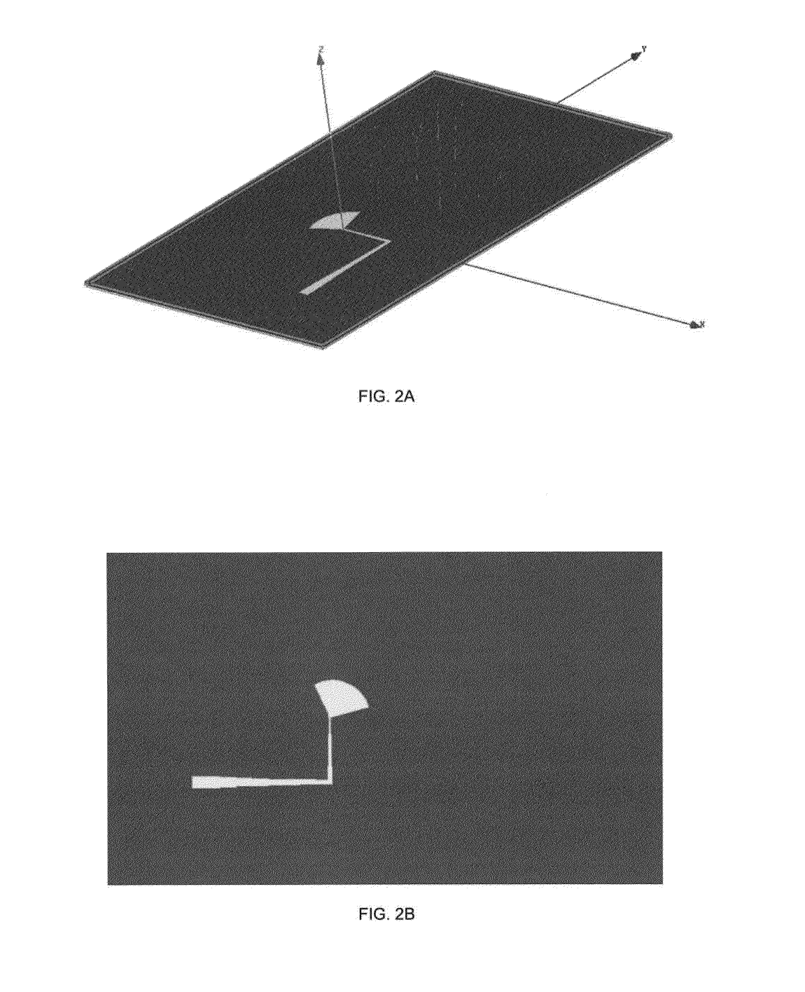

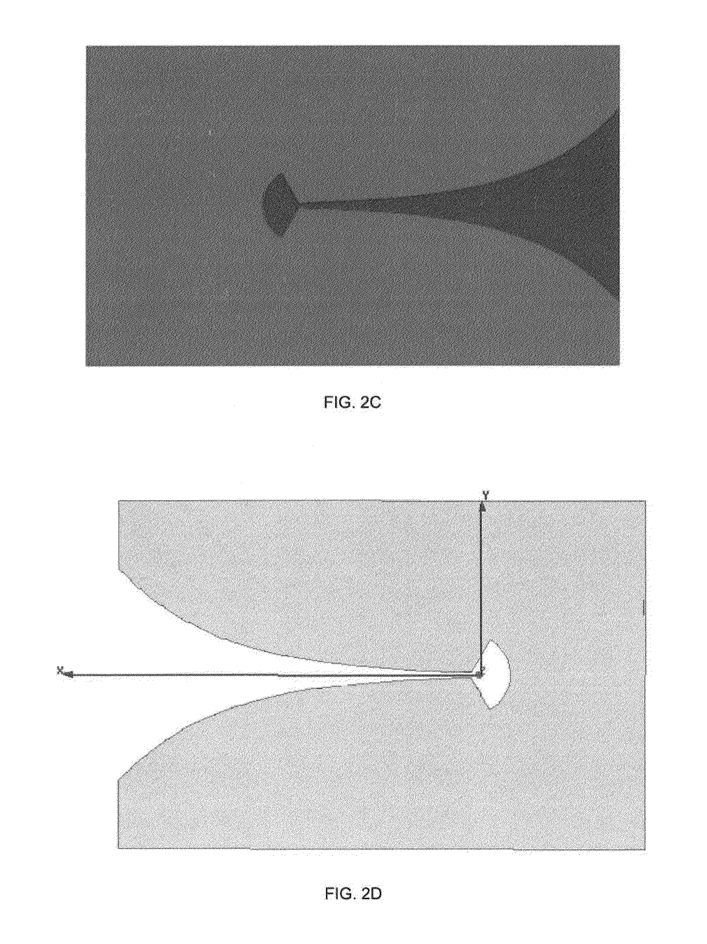

As seen most clearly in FIG. 1B, dielectric substrate 102 can have a substantially semicircular profile. Antenna elements 104a-f can be positioned in an arc, e.g., at substantially uniform angular intervals along the arc. For example, in the depicted embodiments having 6 antenna elements 104a-f, antenna elements can be spaced 36° apart. As seen most clearly in FIGS. 1B, 1C, 2C, and 2D, ground layer 106 can include notches both at the location of the sector 202 of each antenna element 104 as well as between antenna elements 104. The notches adjacent to the antenna elements can have a geometry defined by an exponential function such as y=0.5 e^{0.06x}, wherein x is the distance from an origin along a ray from the origin point of the antenna and y is the distance from the x axis as illustrated in FIG. 2D.

As seen most clearly in FIG. 1B, ground layer 106 can define sector-shaped recesses 108 corresponding to each antenna element 104. Sector-shaped recesses 108 can have a central angle and radius substantially equal to the sector 202 of each antenna element 104 described herein. For example, the central angle of the sector-shaped recesses 108 can be about 120° and the radius can be about 7 mm. Each corresponding sector-shaped recess 108 and sector portion 202 of antenna element 104 can share an origin point In some embodiments, the sector-shaped recesses 108 and sector portion 202 of the corresponding antenna element 104 do not overlap, but radial edges can overlap or nearly abut each other (e.g., within an angle of less than 10° with respect to a common origin).

### Antenna Elements

As depicted in FIGS. 2A and 2B, each antenna element 104 can include a sector 202 and a conductive feed line 204. Sector 202 can have a central angle θ between about 0° and about 180°. Central angle θ can be adjusted to achieve a desired beamwidth from each antenna element 104. In concert, the number of antenna elements in an antenna 100 can be adjusted based on the beamwidth of the antenna elements. For example, narrow sectors 202 may produce narrower beadwidths, necessitating an increased number of antenna elements 104 to provide satisfactory wide-angle coverage.

The sectors depicted herein have a central angle of about 120° and each produce a −3 dB beamwidth having a central angle larger than 50°. As a result, the beams provide overlapping coverage over the 180° antenna spectrum.

In some embodiments, the feed line 204 includes a lateral portion 206. Lateral portion 206 can have a substantially right angle relative to feed line 204 in order to reduce interference. Lateral portion 206 advantageously provides an offset between sector 202 and feed line 204 so that sector portion 202 is not substantially impacted by any magnetic fields generated by electricity flowing through feed line 204.

### Housing

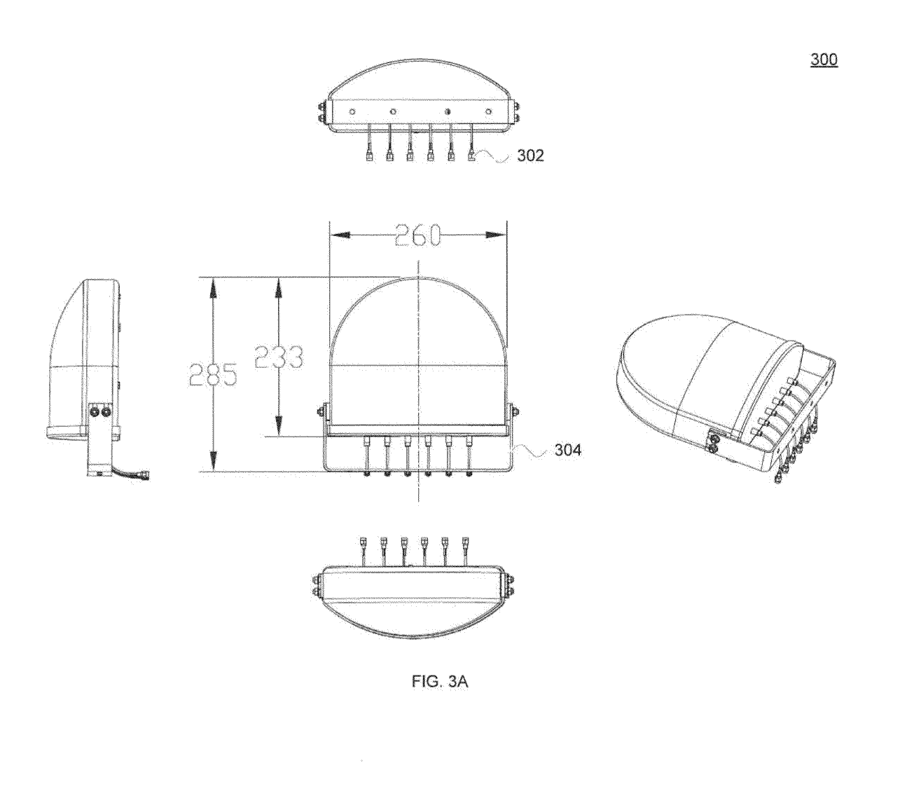

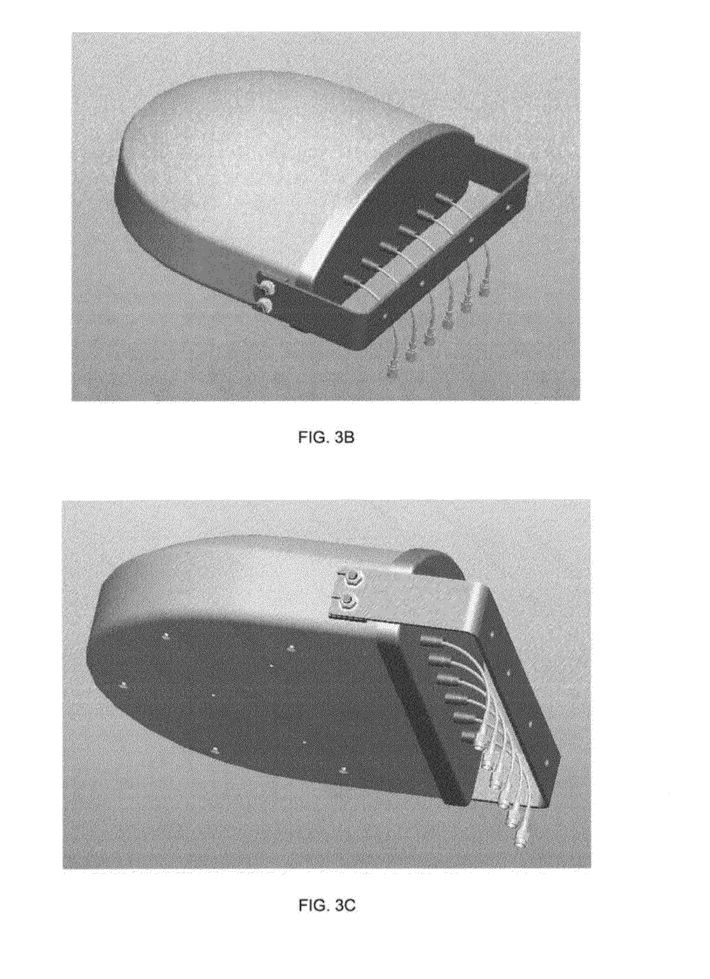

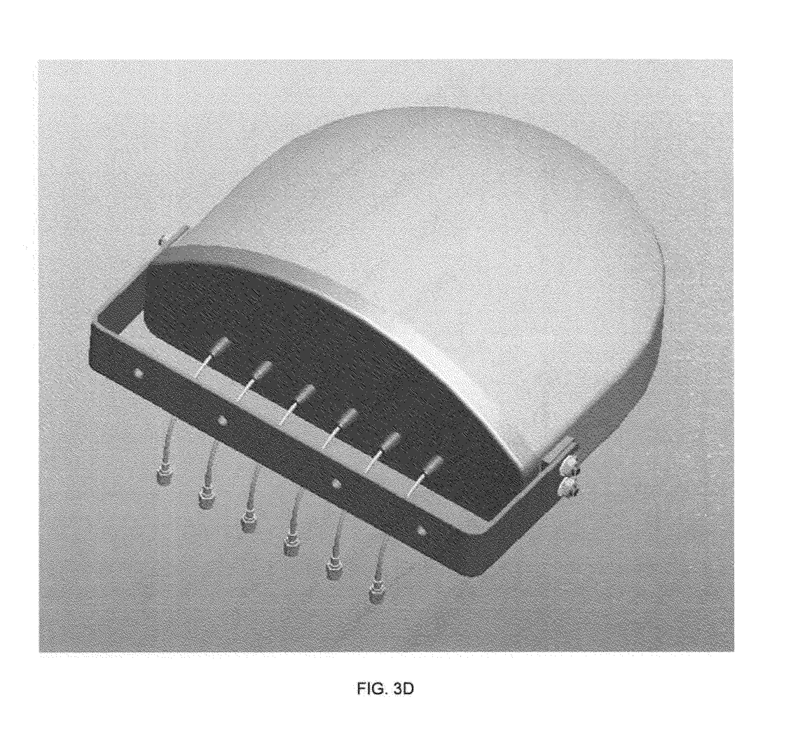

Referring now to FIGS. 3A-3D, the antenna 100 can be surrounded by a housing 300 that can protect, shield, enhance aesthetics of, and/or permit mounting of the antenna. Housing 300 can be a formed from a material such as plastic that is substantially transparent to RF waves.

In some embodiments, one or more connectors 302 are present outside of the housing. Suitable connectors include the coaxial connectors such as Type N connector available from sources such as L-com, Inc of North Andover, Massachusetts. Connectors 302 can be mounted on the housing 300 or can be pigtails (i.e., short lengths of wire terminating in a connector) extending from the housing 300. In multiple-input and multiple-output (MIMO) embodiments, the number of connectors 302 can correspond to the number of antenna elements 104.

Housing 300 can also include a mounting bracket 304, which can permit attachment to a surface, pole, or the like via a fastener such as screw, bolt, or the like.

### Exemplary Antenna Parameters

The antenna described herein can be applied to a variety of applications. In one embodiment, the working frequency is 2.4-2.5 and 4.9-5.9 GHz (supporting the IEEE 802.11 WI-FI networking standard), a voltage standing wave ratio (VSWR) is less than or equal to 2.0, linear (horizontal) polarization, the gain is at least 4.8 dBi at 2.4-2.5 GHz and between 7.0-8.8 dBi at 4.9-5.9 GHz, an omni antenna radiation pattern shape at 180°, a half-circle, plain, antenna mounting, and a microstrip antenna interface.

### Antenna Simulation Results

### Simulation Results for Single Antenna Element

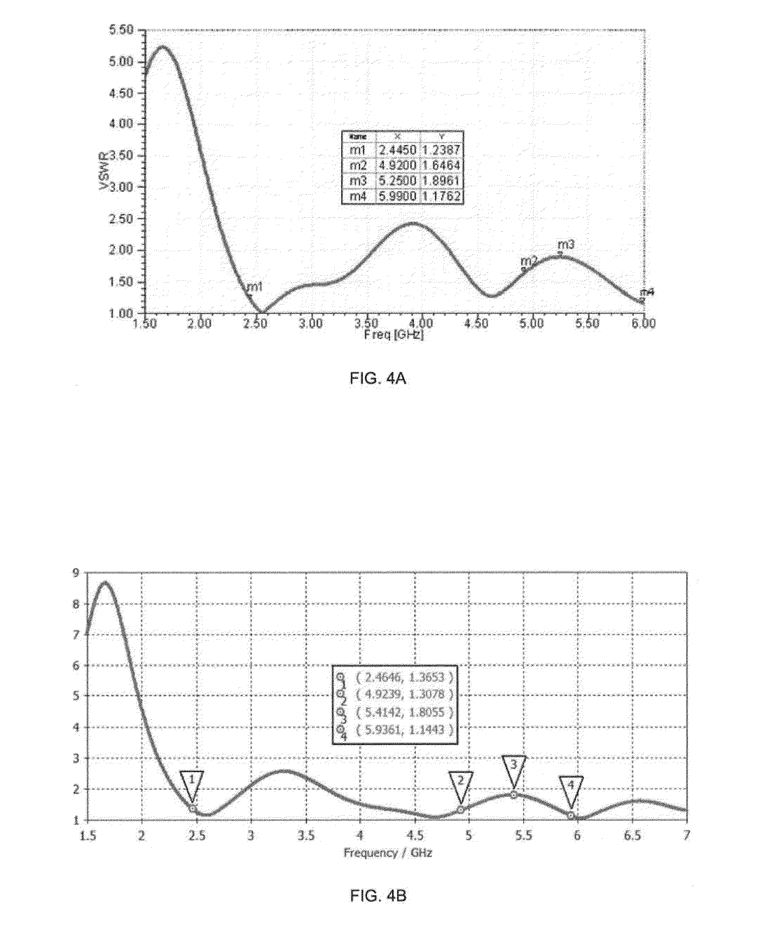

Simulation software was used to analyze salient electrical parameters of an antenna element 104 and corresponding ground layer 106 as depicted in FIGS. 2A-2C. The results are shown in FIGS. 4A and 4B.

As depicted in FIG. 4A, the antenna's VSWR is: 1.23 at 2.45 GHz (m1), 1.64 at 4.92 GHz (m2), 1.89 at 5.25 GHz (m3), and 1.17 at 5.99 GHz (m4). Under the frequency range, VSWR is less than 2.0. As depicted in FIG. 3B, identical when using different simulation software.

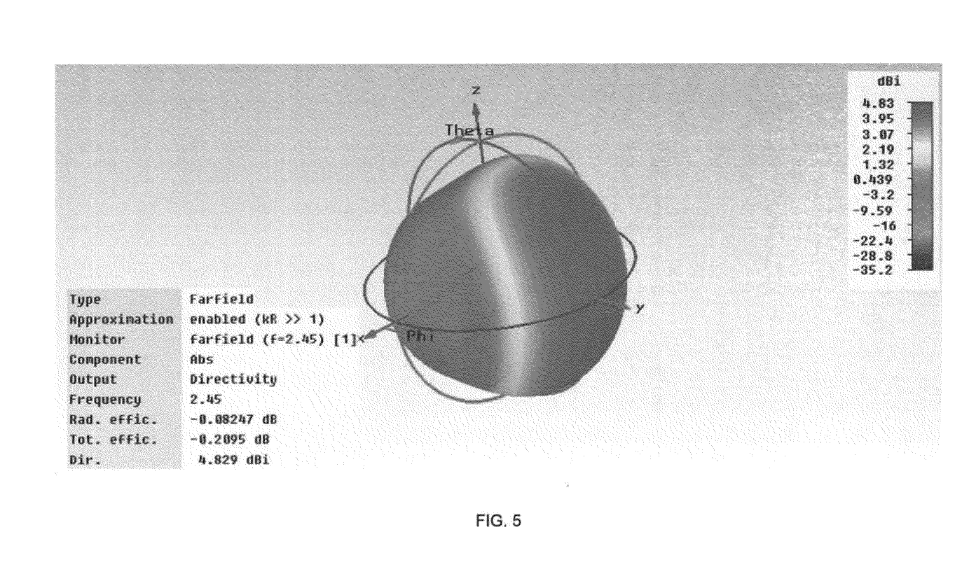

FIG. 5 depicts 3D radiation pattern simulation results at 2.45 GHz. The frame of axes is the same as in FIG. 2A. As depicted, the antenna has 4.83 dBi gain at 2.45 GHz.

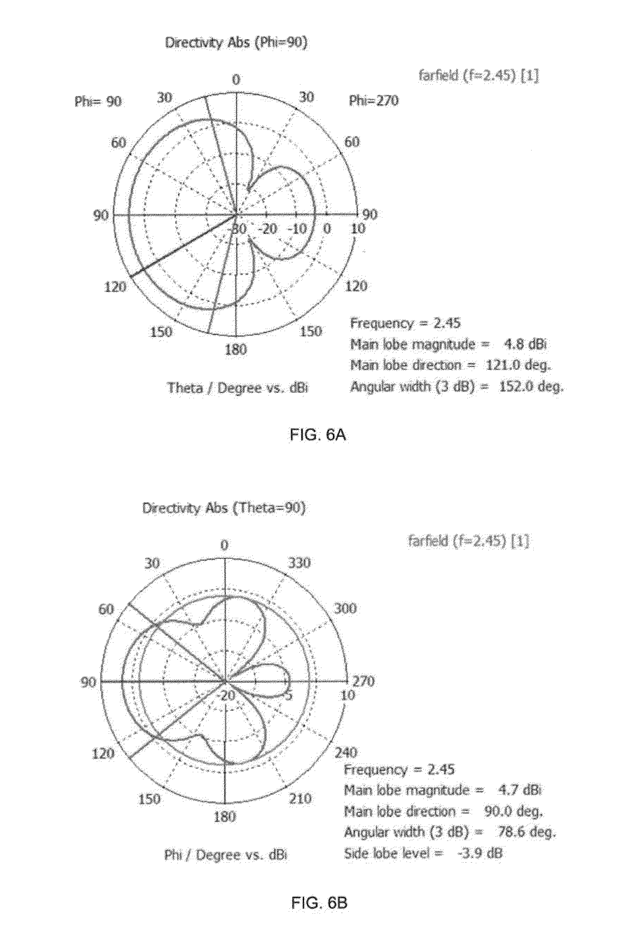

FIGS. 6A and 6B depict YOZ and XOY plane simulation results at 2.45 GHz. As seen in the YOZ plane radiation pattern depicted in FIG. 6A, the −3 dB beamwidth in the YOZ plane is about 152° at 2.45 GHz. As seen in FIG. 6B, when Theta=90°, the −3 dB beamwidth in the XOY plane is 78.6°. The feedback (F/B) is about 10 dB.

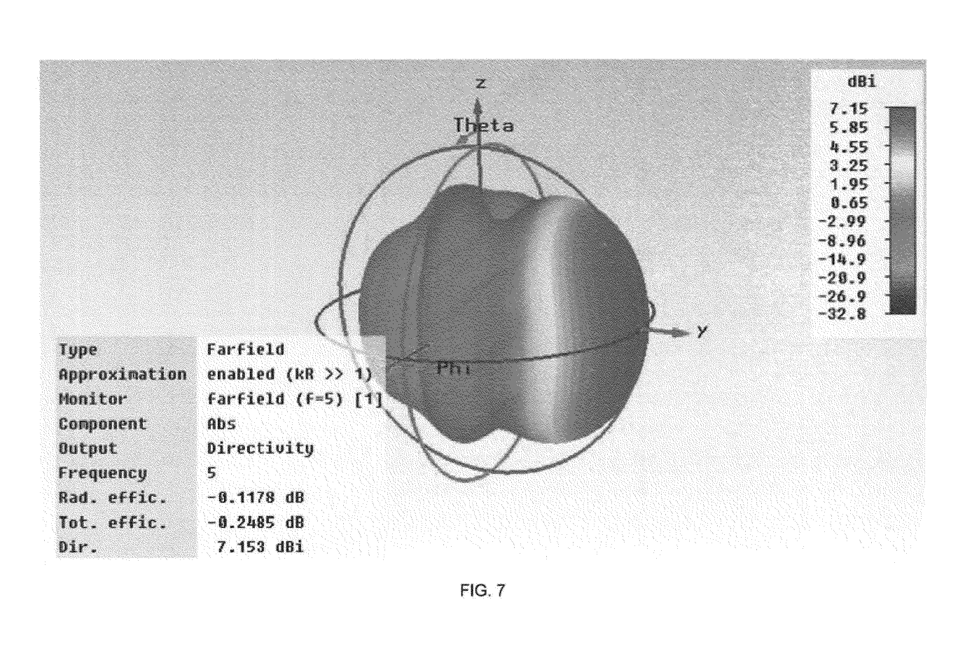

FIG. 7 depicts 3D radiation pattern simulation results at 5 GHz. The frame of axes is FIG. 7 is the same as in FIG. 2A. As seen, the antenna has 7.15 dBi gain at 5 GHz.

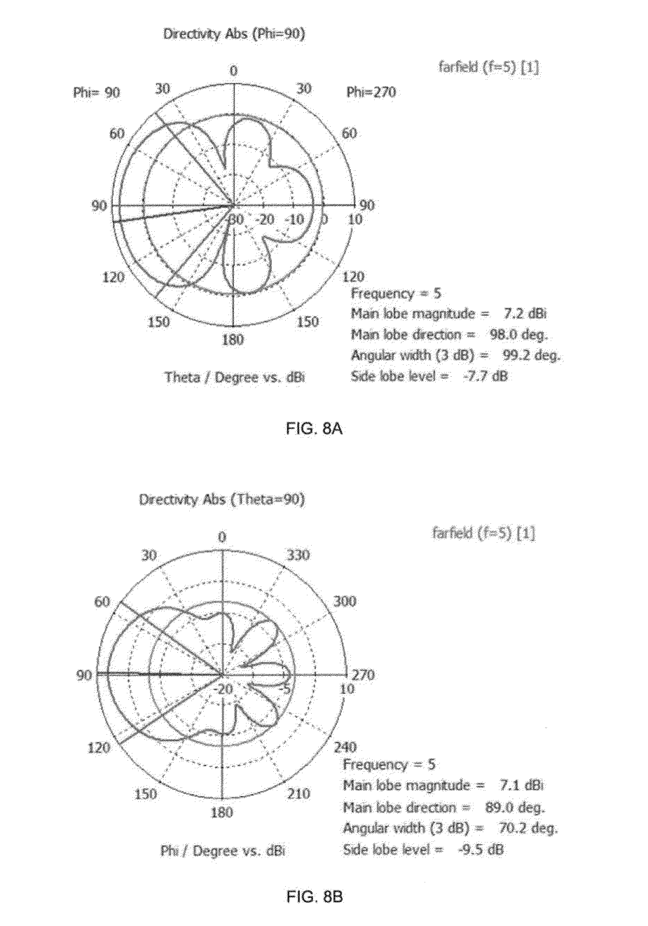

FIGS. 8A and 8B depict YOZ and XOY plane simulation results at 5 GHz. As seen in the YOZ plane radiation pattern depicted in FIG. 8A, the −3 dB beamwidth in the YOZ plane is about 99.2° at 5 GHz. As seen in FIG. 8B, when Theta=90°, the −3 dB beamwidth in the XOY plane is 70.2°. The feedback (F/B) is about 10 dB.

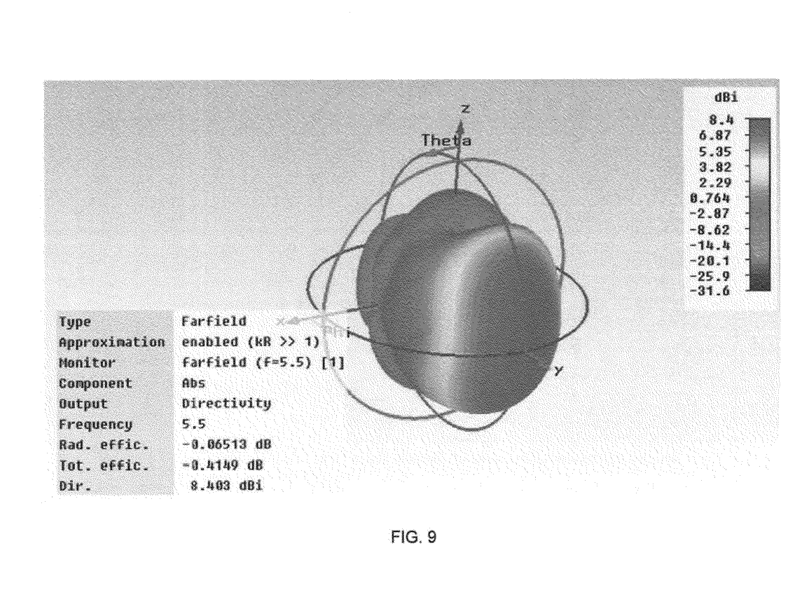

FIG. 9 depicts 3D radiation pattern simulation results at 5.5 GHz. The frame of axes is the same as in FIG. 2A. As seen, the antenna has 8.4 dBi gain at 5.5 GHz.

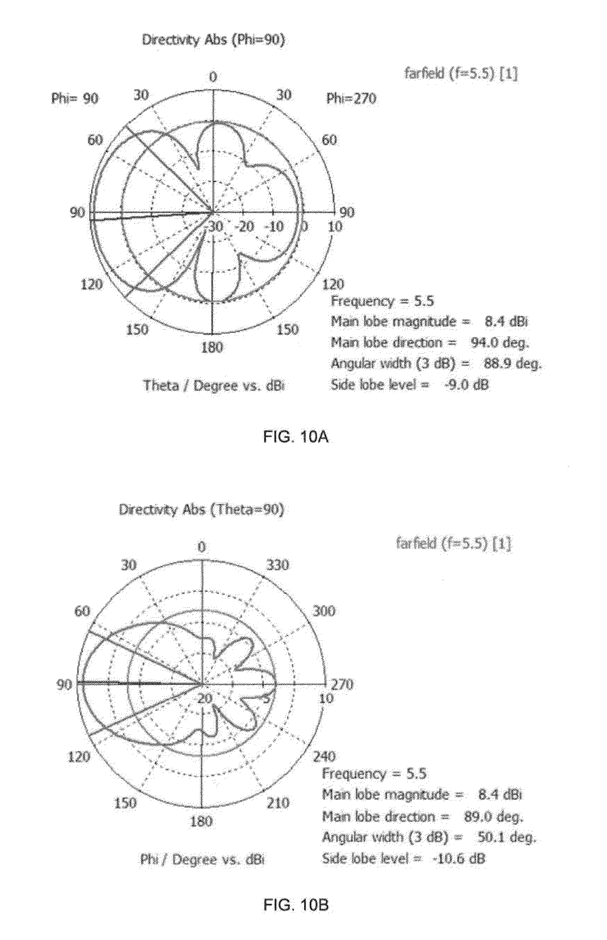

FIGS. 10A and 10B depict YOZ and XOY plane simulation results at 5.5 GHz. As seen in the YOZ plane radiation pattern depicted in FIG. 10A, the −3 dB beamwidth in the YOZ plane is about 88.9° at 5.5 GHz. As seen in FIG. 10B, when Theta=90°, the −3 dB beamwidth in the XOY plane is 50.1°. The feedback (F/B) is about 10 dB.

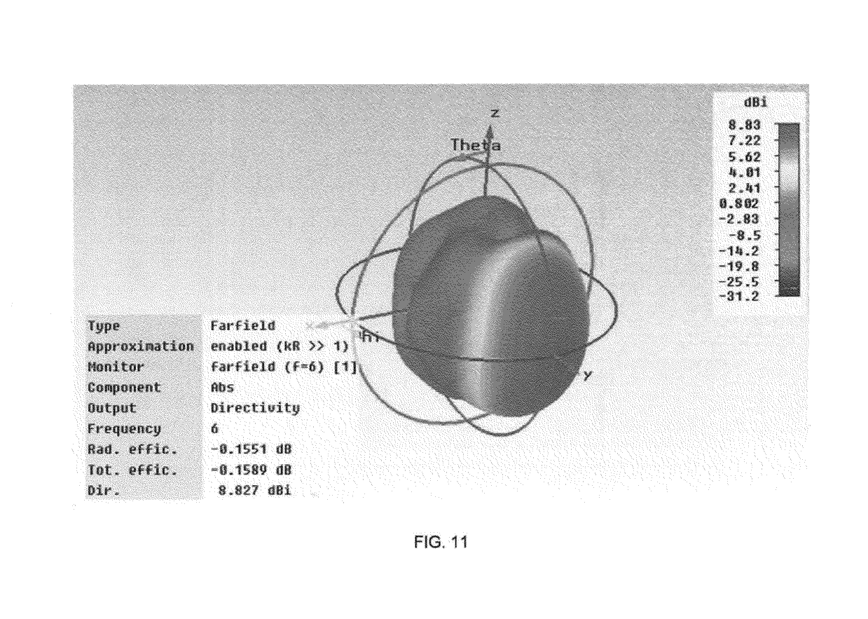

FIG. 11 depicts 3D radiation pattern simulation results at 6 GHz. The frame of axes is FIG. 10 is the same as in FIG. 2A. As seen, the antenna has 8.82 dBi gain at 6 GHz.

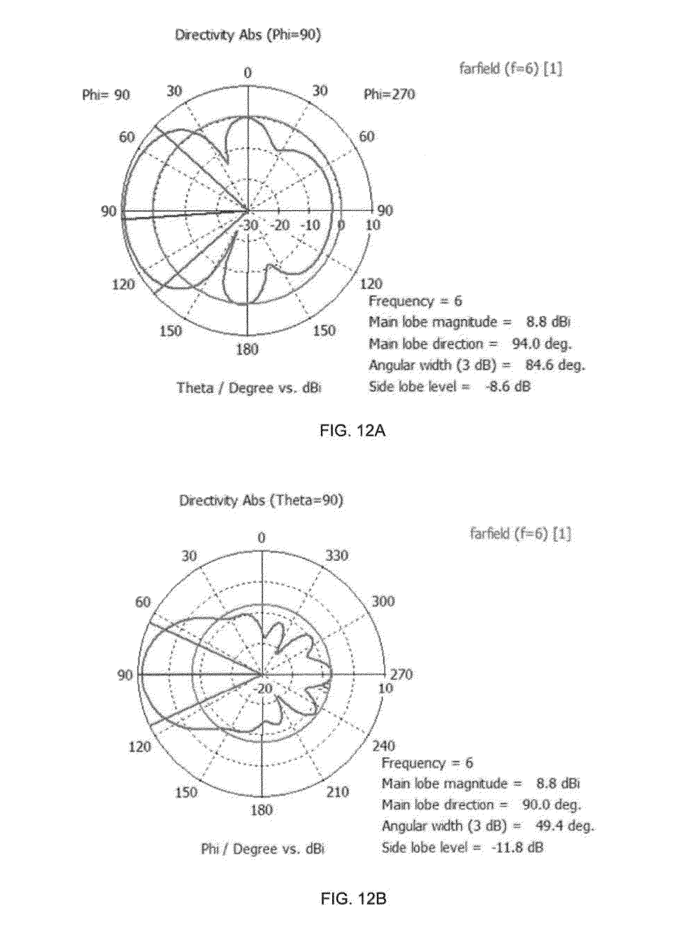

FIGS. 12A and 12B provides YOZ and XOY plane simulation results at 6 GHz. As seen in the YOZ plane radiation pattern depicted in FIG. 12A, the −3 dB beamwidth in the YOZ plane is about 84.6° at 6 GHz. As seen in FIG. 12B, when Theta=90°, the −3 dB beamwidth in the XOY plane is 49.4°. The feedback (F/B) is about 10 dB. Impedance Stability Verification

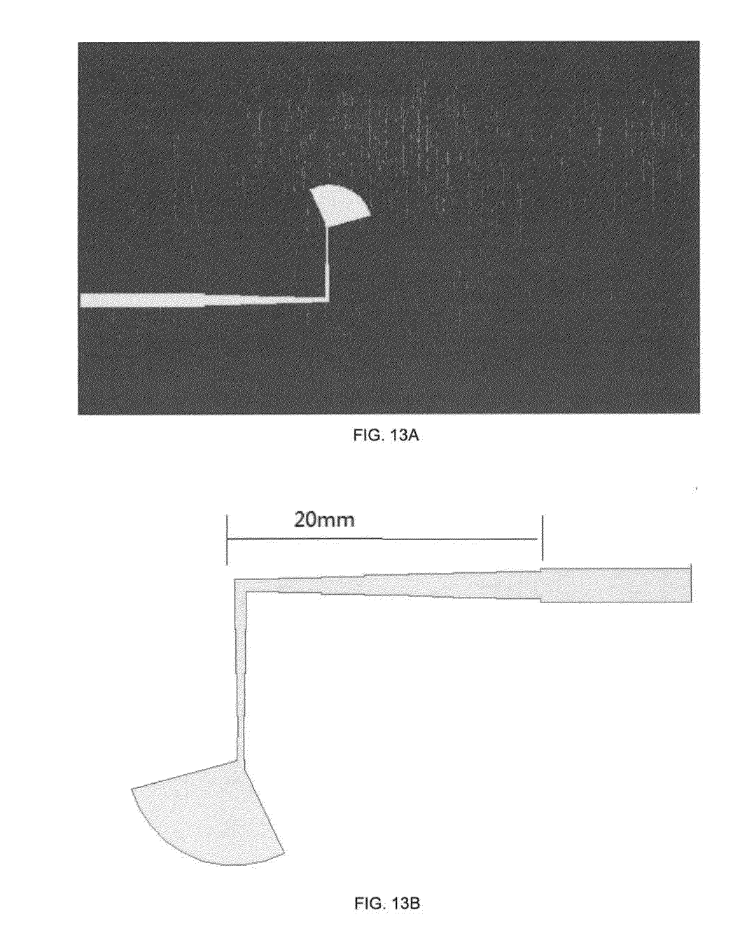

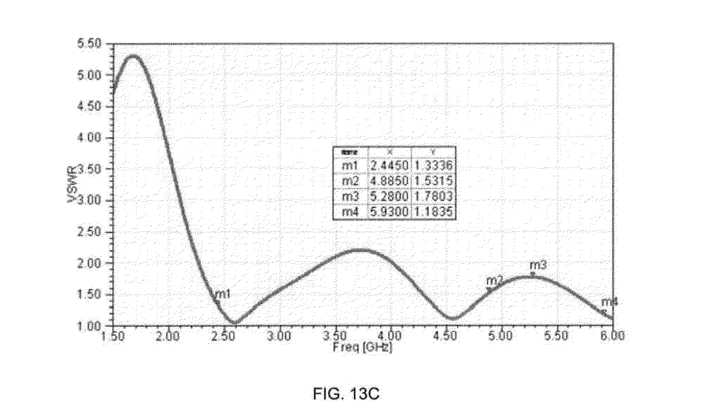

Referring now to FIGS. 13A and 13B, the 40 mm, 50Ω standard feed line of the antenna element was increased by 20 mm in order to verify impedance stability. As depicted in FIG. 13C, the VSWR remains acceptable after the length of the feed line is increased.

Referring now to FIGS. 14A and 14B, the 40 mm, 50Ω standard feed line of the antenna element was increased by 40 mm in order to verify impedance stability. As depicted in FIG. 14B, the VSWR remains acceptable.

From FIGS. 13A-14B, it can be seen that impedance of antenna element 104 is stable.

### Simulation Results for Antenna Array

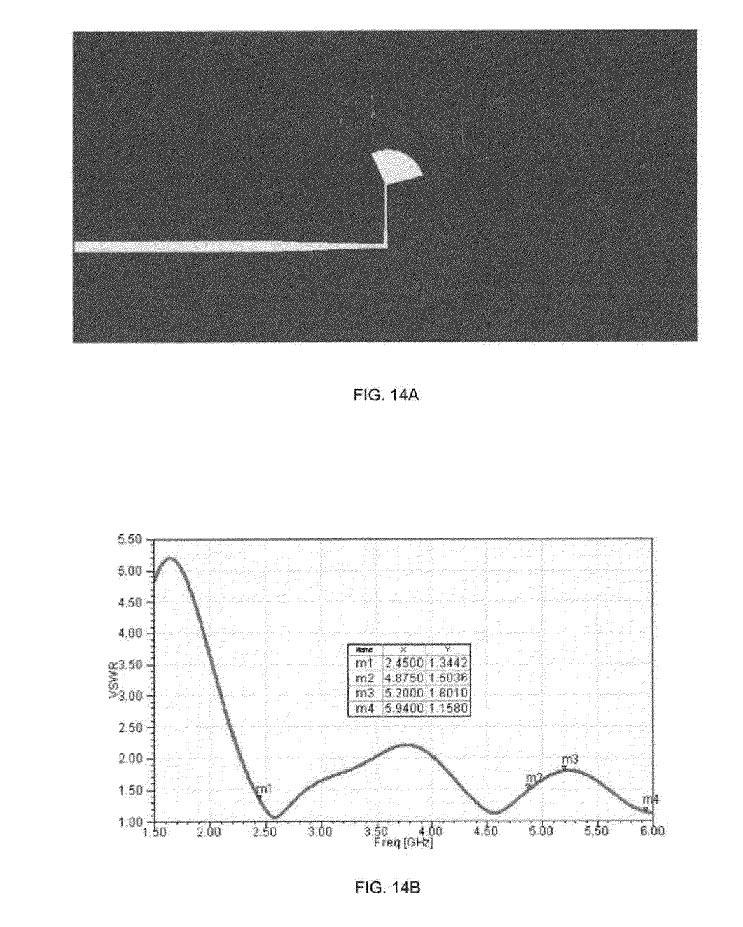

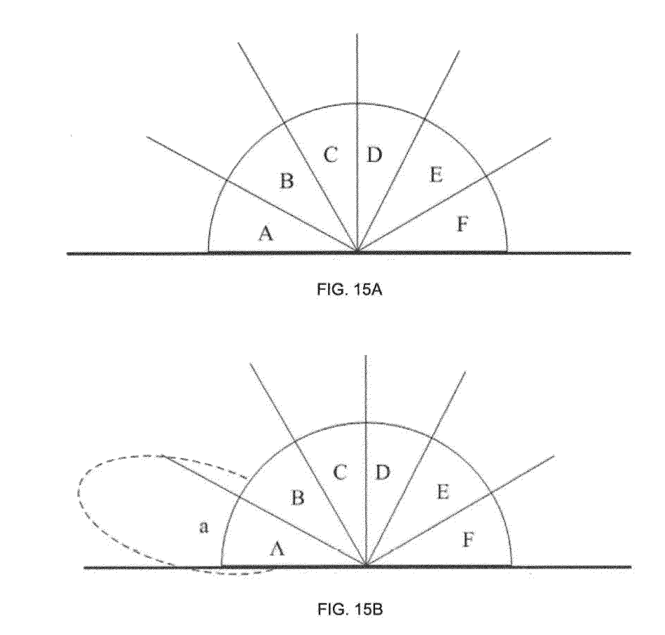

Referring now to FIG. 15A, a half circle is divided into 6 sections, A, B, C, D, E, and F. Every section has almost the same or nearly the same horizontal angle. (Because Sections A and F have mounting angle concerns, the angle of A and F can differ slightly from the other angles.) Suppose that A+B+C+D+E+F=180°, A=F, and B=C=D=E=F. FIG. 15B depicts the radiation patterns of antenna a in section A. FIG. 15C depicts the radiation patterns of antenna b in section B.

All six antenna elements can be single-way radiation antenna elements, but at the YOZ plane (vertical plane), the beamwidth is wide and gain is big. At the XOY plane, the angle is narrower. Suppose there is one antenna at section A. Antenna a can cover the far field of section A. In section A, even if there is affection from other antennas (such as from section B and C), antenna “a” has strongest signal strength in section A. At the same time, each antenna's gain is more than 4 dBi. Antenna b has the same performance in section B. The result is that each one of six antennas covers one area separately. The YOZ plane has a wide −3 dB beamwidth, which can ensure that the “−Z” axis direction has a large gain.

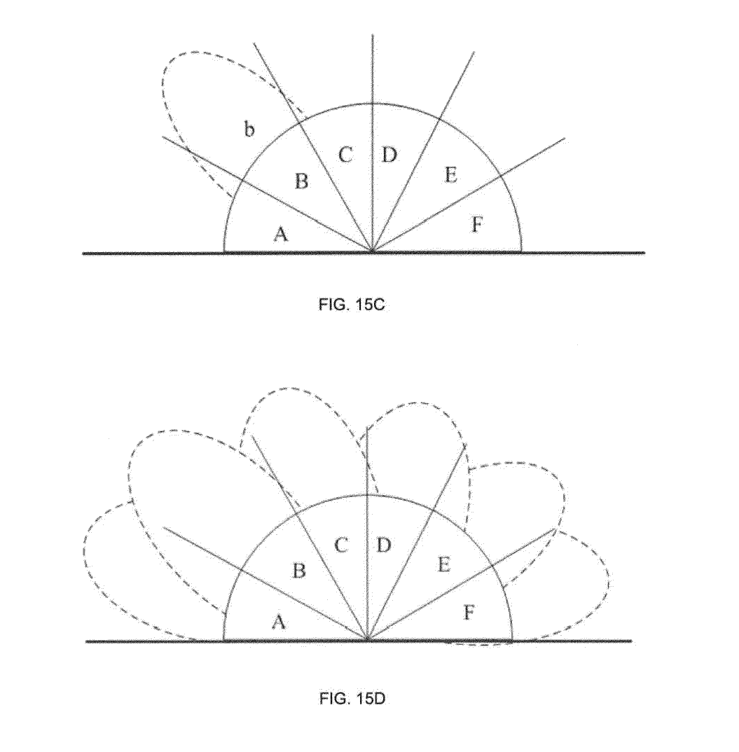

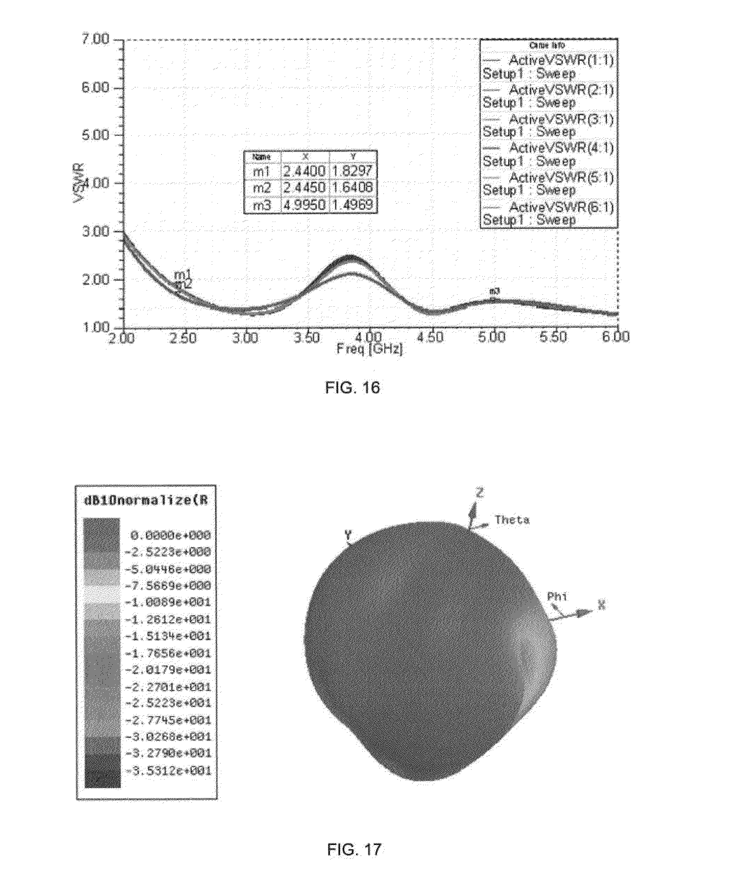

Simulation software was used to analyze the salient electrical parameters of the antenna depicted in FIGS. 1A-1D. FIG. 16 plots the antenna's VSWR at various frequency. The antenna's VSWR is 1.82 at 2.44 GHz (m1), 1.64 at 2.445 GHz (m2), and 1.49 at 4.99 GHz (m3). The VSWR chart of FIG. 16A considers the mutual current affection.

FIG. 17 depicts 3D radiation patterns simulation result for 2.45 GHz. The frame of axes is the same as that in FIG. 1A.

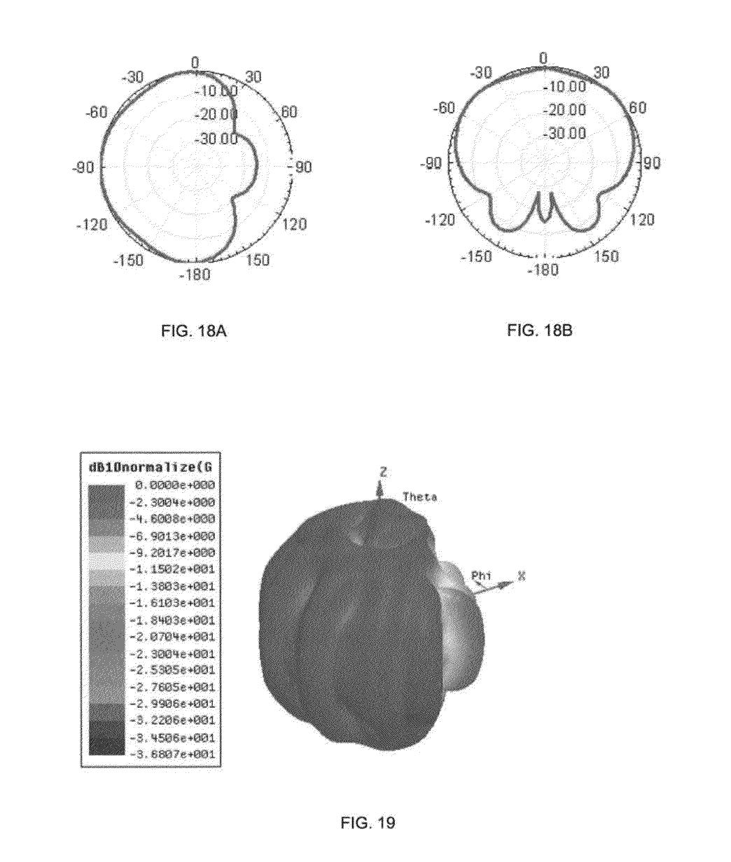

FIGS. 18A and 18B depict YOZ and XOY plane simulation results, respectively, at 2.45 GHz. As seen in FIG. 18A, the antenna has wide beamwidth in the XOZ plane at 2.45 GHz. As depicted in FIG. 18B, the antenna signal can cover all areas in the XOY plane at 0 degree.

FIG. 19 depicts 3D radiation patterns simulation results for 4.9 GHz. The frame of the axes is the same as that in FIG. 1A.

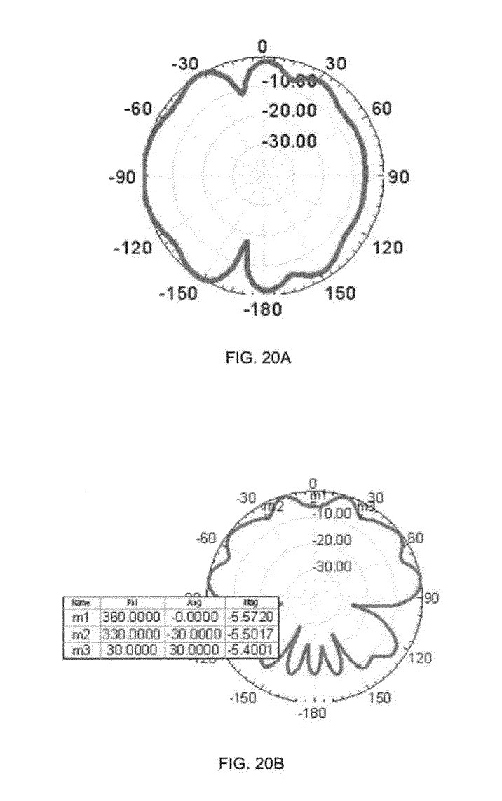

FIGS. 20A and 20B depict YOZ and XOY plane simulation results, respectively, at 4.9 GHz. As seen in FIG. 20A, the antenna has a sufficient coverage area. As depicted in FIG. 20B, the radiation pattern covers the front area with a wave shape (0 degree direction). At m1, Phi=360, the gain value is −5.57; at m2, Phi=330, the [GAIN?] value is −5.50; at m3, Phi=30, the gain value is −5.4.

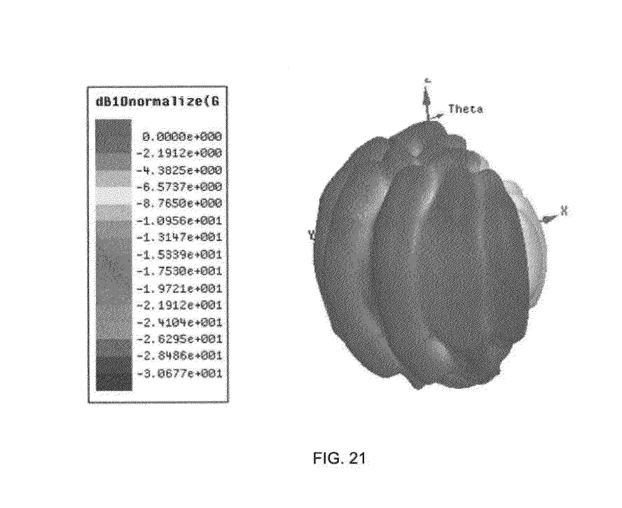

FIG. 21 depicts a 3D radiation patterns simulation result for 5.5 GHz. The frame of axes is the same as that in FIG. 1A.

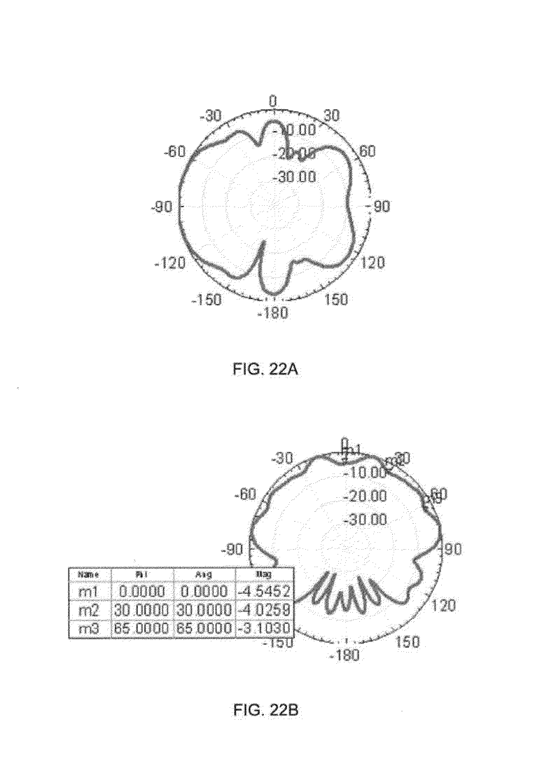

FIGS. 22A and 22B depict YOZ and XOY plane simulation results, respectively, at 5.5 GHz. As seen in FIG. 22A, the antenna has a sufficient coverage area. As depicted in FIG. 20B, the radiation pattern covers the front area with a wave shape (0 degree direction). At m1, Phi=360, the gain value is −4.54; at m2, Phi=30, the gain value is −4.00; at m3, Phi=65, the gain value is −3.10.

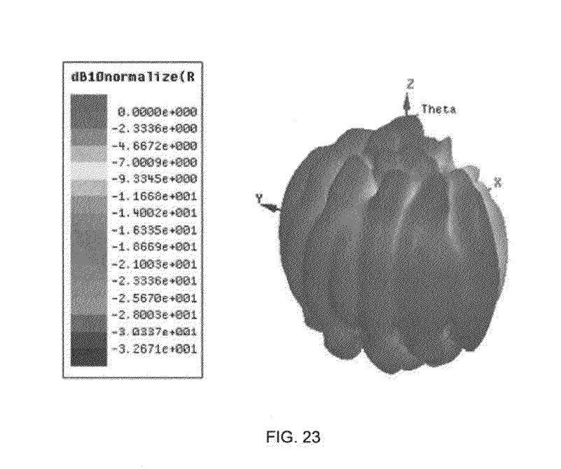

FIG. 23 depicts a 3D radiation patterns simulation result for 5.9 GHz. The frame of axes is the same as that in FIG. 1A.

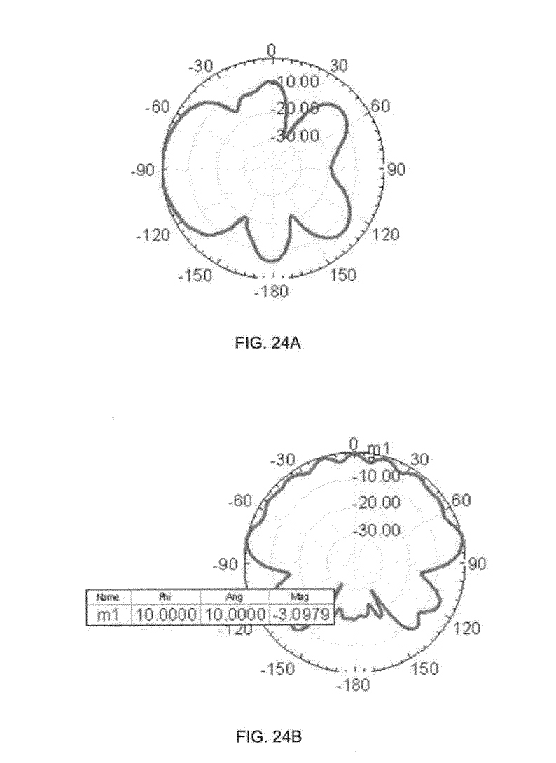

FIGS. 24A and 24B depict YOZ and XOY plane simulation results, respectively, at 5.9 GHz. As seen in FIG. 24A, the antenna has a sufficient coverage area. As depicted in FIG. 24B, the radiation pattern covers the front area with a wave shape (0 degree direction).

### Equivalents

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. An antenna comprising:
a dielectric substrate; and
a plurality of antenna elements positioned on a surface of the dielectric substrate, each antenna element comprising:
a sector-shaped sheet of conductive material; and
a conductive feed line coupled to the sector-shape sheet of conductive material.

2. The antenna of claim 1, wherein the plurality of antenna elements are arranged in an arc.

3. The antenna of claim 2, wherein the plurality of antenna elements are positioned at substantially uniform angular intervals along the arc.

4. The antenna of claim 1, wherein the plurality of antenna elements consists of six antenna elements.

5. The antenna of claim 1, wherein the sector-shaped sheet of conductive material has a central angle between about 0° and about 180°.

6. The antenna of claim 1, wherein the sector-shaped sheet of conductive material has a central angle between about 90° and about 180°.

7. The antenna of claim 1, wherein the sector-shaped sheet of conductive material has a central angle selected from the group consist of: between about 90° and about 100°, between about 100° and about 110°, between about 110° and about 120°, between about 120° and about 130°, between about 130° and about 140°, between about 140° and about 150°, between about 150° and about 160°, between about 160° and about 170°, and between about 170° and about 180°.

8. The antenna of claim 1, wherein the conductive feed line includes a longitudinal portion and a lateral portion adjacent to the sector-shaped sheet of conductive material and at a substantially right angle to the longitudinal portion.

9. The antenna of claim 1, further comprising:
a ground layer mounted to an opposite side of the dielectric substrate from the plurality of antenna elements.

10. The antenna of claim 1, further comprising:
a plurality of RF connectors, each RF connector associated with one of the plurality of antenna elements.

11. The antenna of claim 1, further comprising:
a housing surrounding the substrate and the plurality of antenna elements.

12. An antenna comprising:
a dielectric substrate;
a plurality of antenna elements positioned on a surface of the dielectric substrate at substantially uniform angular intervals along an arc, each antenna element comprising:
a sector-shaped sheet of conductive material having a central angle between about 90° and about 180°; and
a conductive feed line coupled to the sector-shape sheet of conductive material, the conductive feed line including a longitudinal portion and a lateral portion adjacent to the sector-shaped sheet of conductive material and at a substantially right angle to the longitudinal portion; and
a ground layer mounted to an opposite side of the dielectric substrate from the plurality of antenna elements.

13. A printed-circuit board antenna comprising:
a dielectric substrate; and
at least six antenna elements etched on a surface of the dielectric substrate to form a 3×3 MIMO array, each antenna element comprising:
a sector-shaped sheet of conductive material; and
a conductive feed line coupled to the sector-shape sheet of conductive material.
